(19) United States
(12) Patent Application Publication
(10) Pub. No.: US 2005/0149351 A1
(43) Pub. Date: Jul. 7, 2005

(54) Method of businessman hospital inquiring system

(76) Inventors: Jiao Gong, Arcadia, CA (US); Wei Jiang, Arcadia, CA (US)

Correspondence Address: James Chen, 150 N Santa Anita Ave., #560, Arcadia, CA, 91006, US

(21) Appl. No.: 10/746,364

(22) Filed: Dec. 29, 2003

(51) Int. Cl. G06F 17/60

(52) U.S. Cl. 705/2

(57) ABSTRACT

In 2003, Angel and Gelange in US achieved a Nobel Economical Award for their ARCH and conformity method. An ARCH indicates changing and waving as time change, no stability and heterogeneity variation number model in self-return condition, which emphasizes variation number conception of no stability period in economic action. This concept is the same of concept of no stability and heterogeneity variation number of enterprise 64 periods in business hospital inquiring system, but belongs to two different systems. The businessman hospital inquiring system invention involves a innovation technology, which use computer diskette, keyboard operation system to display software dictionary information on screen and coding text information and select or inquire content of enterprise different development time by clicking code (keyboard and key position). It belongs to a technology of word code method. An enterpriser gets different action directions and warnings in different time and reduces failure rate and raises success rate by inquiring developing content in different periods on code screen, which solves disadvantage of slow inquiring, low efficiency. The method character of Chinese word code, its keyboard character used, define of each key position and each key position appear on position are related one by one.

### BRIEF SUMMARY OF THE INVENTION

The method of businessman hospital inquiring system belongs to computer program inventive patent in U.S. patent. This invention involves a new technology, which use computer diskette, keyboard operation system to display software dictionary information on screen and coding text information and select or inquire content of enterprise different development time by clicking code keyboard and key position.

In 1996, US Patent and Brand Bureau issued check guide line about invention deal with computer, which check guide line divide applying patent object into protected object and non-protected object by law. This check guideline prescribed that computer program and data structure etc. that is functional description material is not a protected patent object by itself. But if a carrier that can be read by computer includes a computer program and the program set up a functional or structure link between the program and carrier to realize program function, it is considered to belong to protected object by patent law. In the same way, if a carrier that can be read by computer includes data structure and the data structure set up a functional or structure link between data structure and carrier that realize data structure function, it will be one of protected object types by law.

An enterprise will be divided into 64 periods and each period will be divided into 6 structure levels and use code data to marking it. When some code in 6 structure levels changes as the accord, data, level, it will make determined enterprise period change to another code data marking period. This change is completed by computer diskette, keyboard operation system with just click code keyboard according to preset program, to realize the patent condition of setting up functional and structure link between it and realizing its function carrier with the data structure.

At Oct. 8^{th}, 2003, Angel and Gelange achieved a Nobel Economical Award for their ARCH and conformity method. In 1982, Angel has put forward two new statistic methods to deal with two big particularities in many time sequences, i.e. changing and waving as time as well no stability. This new statistic method is called as a heterogeneity variation number model in self-return condition, which solve variation number problem in sequence and explain important character in enterprise finance time sequence information successfully. The heterogeneity variation number model called ARCH in self-return condition is not only become a want tool for researcher, but also become a main base for understanding capital price change and estimating invest combination risk.

The correlation of businessman hospital inquiring system with Angel ARCH theory is to emphasize the wave no-stability as time change and heterogeneity variation number model in sequence. Angel only emphasizes the economic or financial data change wave no-stability and heterogeneity variation number model in sequence as time change. The businessman hospital emphasizes that enterprise change rule of wave no-stability and heterogeneity variation number model in sequence as time change in enterprise whole 64 periods variation progress

The difference between the businessman hospital inquiring system and Angel ARCH is that Angel ARCH is a open, unknown future no stability variation number model, however businessman hospital inquiring system is a close, circle known future no stability variation number model. They are two different system at all. Angel ARCH broken the tradition that researcher validate the hypothesis and relation of economic theory by change in time sequence and know US gross GDP, price, interest, stock price by time sequence. This self return model of condition heterogeneity variation number emphasize the variation of no stability in time sequence.

### BRIEF SUMMARY OF THE INVENTION

The businessman hospital inquiring system invention involves a innovation technology, which use computer diskette, keyboard operation system to display software dictionary information on screen and coding text information and select or inquire content of enterprise different development time by clicking code (keyboard and key position). It belongs to a technology of word code method. An enterpriser gets different action directions and warnings in different time and reduces failure rate and raises success rate by inquiring developing content in different periods on code screen, which solves disadvantage of slow inquiring, low efficiency. The method character of Chinese word code, its keyboard character used, define of each key position and each key position appear on position are related one by one.

Enterprise organization action science will take place change of hypostasis and quantity degree as easy change in different time and different period. In change, it includes direction and adjustment of organization action for businessman. A businessman must know that the fallow conflict and hidden trouble have existed before easy change take places and these conflict and hidden trouble affirm to take place. During it change to other easy change, businessman must always watch out for inherence conflict and hidden trouble to produce big or small strong collision finally No matter it involves strong or weak two sides change and transformation, the collision result of these inherence conflict and hidden trouble will take place an advance or retreat change and result an easy change in period. During these easy changes, it will take place important personal affair change certainly. During the easy change, it will produce a new and temporary stable period and replace an old period with a new one. At this time, businessman must suit for this coming period by new management way, organization model, personal change. However, businessman must realize that meaning conflict in old period still exist, during new period. If you cannot deal with them, it does not avoid happening the circle movement from new period to old period. To accelerate it to transform toward old period or to prevent it to do, the direction and means of organization action taken by businessman will exert very important effect. It is the businessman hospital inquiring system that showing the wave no-stability as time change and the procedure and program of no stability variation number of heterogeneity variation number model on sequence in enterprise.

To determine rule of measuring transformation, quantity change and quality change in each time and each period on enterprise, we take the key kernel data in enterprise state nature and quantity in currency world usage, ie. the ratio of enterprise (year, month) distribute goods vs. return payment; the ratio of enterprise (year, month) selling amount vs. management(include advertising) cost; the ratio of enterprise (year, month) accumulated gathering vs. selling amount; enterprise (year, month) average profit rate; enterprise (year, month) total capital debt rate; the ratio of enterprise (year, month) scientific & technological invest vs. total selling amount and total profit amount. This data is kernel one used to determine quality of running enterprise in world usage.

According to standard of businessman hospital inquiring system, the enterprise measurement delamination structure is arranged as following:
F1—the ratio of enterprise (year, month) scientific & technological invest vs. total selling amount
E0—enterprise (year, month) total capital debt rate
D1—enterprise (year, month) average profit rate
C0—the ratio of enterprise (year, month) accumulated gathering vs. selling amount
B1—the ratio of enterprise (year, month) selling amount vs. management cost
A0—the ratio of enterprise (year, month) distribute goods vs. return payment

We divide all enterprises in every field and every scale of industries into three levels and set up three limits of kernel data for each enterprise again, that is:
(1) matter change limit
(2) quantity change warning limit
(3) Normal waving limit

An enterprise or businessman just depends on the change aroused by key and kernel data in enterprise running and uses defined character, nature, means, method, warning for now and future period by business hospital to deal with the future need problems, so supply function for decision supporting and controlling & driving future.

According to above no stability variation number, a businessman hospital inquiring system divides whole enterprise development into 64 periods and set up variation delamination structure codes, that is:

| | | | | | | | | | | | |
|---|---|---|---|---|---|---|---|---|---|---|---|
| 000 | 000 | heaven, | 111 | 111 | earth, | 011 | 101 | register, | 101 | 110 | training, |
| 111 | 101 | Plan, | 101 | 000 | contention, | 101 | 111 | business war, | 111 | 101 | cooperation, |
| 000 | 100 | supervising, | 001 | 000 | implement, | 000 | 111 | fluency, | 111 | 000 | block, |
| 010 | 000 | communication, | 000 | 010 | own, | 110 | 111 | humility, | 111 | 011 | rest, |
| 011 | 001 | Decision, | 100 | 110 | remove embezzlement, | 001 | 111 | check, | 111 | 100 | culture, |
| 011 | 010 | Rule of law, | 010 | 001 | marking, | 111 | 110 | decline, | 011 | 111 | recovery, |
| 011 | 000 | Grow up, | 000 | 110 | control, | 011 | 110 | manage finance, | 100 | 001 | mature, |
| 101 | 101 | heavy frustration, | 010 | 010 | reorganization, | 110 | 001 | exchanges, | 100 | 011 | carry out, |
| 110 | 000 | retreat, | 000 | 011 | monopoly, | 111 | 010 | competition, | 010 | 111 | wound, |
| 010 | 100 | family, | 001 | 010 | rift, | 110 | 101 | stop, | 101 | 100 | tidy up, |
| 101 | 110 | Simplify, | 011 | 100 | encourage, | 000 | 001 | break off, | 100 | 000 | prevent, |
| 111 | 001 | Unify, | 100 | 111 | increase, | 101 | 001 | run aground, | 100 | 101 | marketing, |
| 010 | 001 | Replace, | 100 | 010 | creative, | 011 | 011 | chief, | 110 | 110 | limit, |
| 110 | 100 | Motion, | 001 | 011 | very intimate, | 010 | 011 | appear on market, | 110 | 010 | move, |
| 100 | 100 | Management, | 001 | 001 | advertise, | 101 | 100 | long-lost, | 001 | 101 | forbear, |
| 001 | 100 | credit, | 110 | 011 | mistake, | 010 | 101 | set, | 101 | 010 | transformation |

### BRIEF DESCRIPTION OF THE SEVERAL VIEWS OF THE DRAWING

Table 1 delamination structure table in standard model of businessman hospital inquire system philosophy

Table 2 delamination structure table in standard model of businessman hospital inquire system for business management

Table 3 delamination structure table in standard model of businessman hospital inquire system for person with ability

Table 4 delamination structure table in standard organizing model of businessman hospital inquire system for business

Table 5 delamination structure table in management & distribution model of businessman hospital inquire system

Table 6 procedure for each period and each time quantity change in businessman hospital inquire system

Table 7 64 period partition in businessman hospital inquire system

Table 8 code of businessman hospital inquire system

TABLE 1
Delamination structure table in standard model of
businessman hospital inquire system philosophy

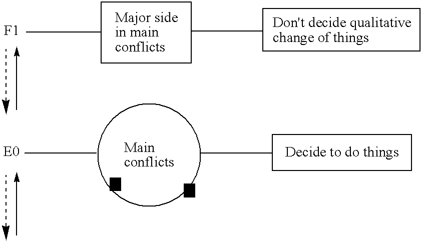

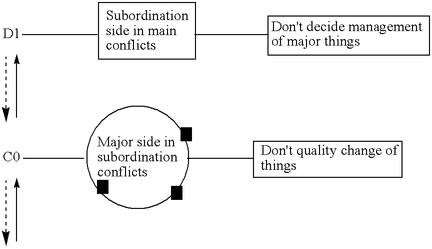

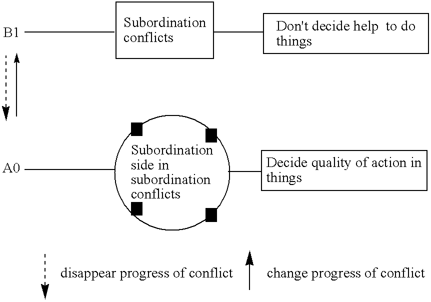

TABLE 2
Delamination structure table in standard model of businessman
hospital inquire system for business management

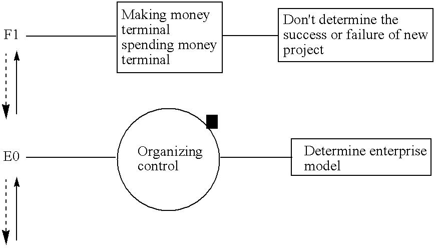

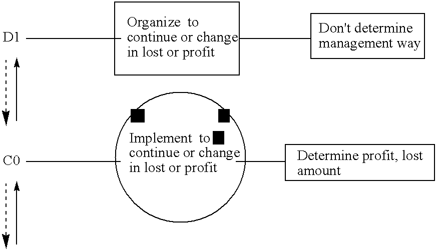

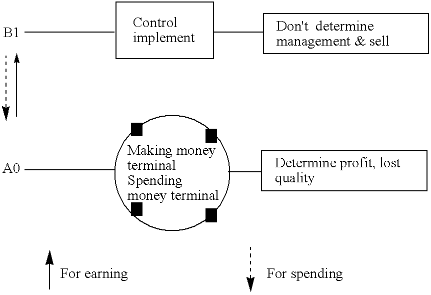

TABLE 3
Delamination structure table in standard model of businessman
hospital inquire system for person with ability

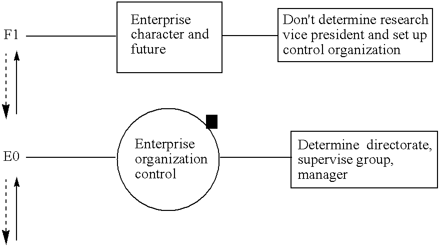

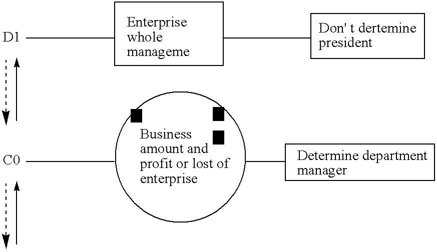

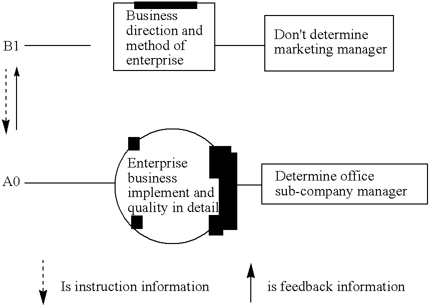

TABLE 4
Delamination structure table in standard organizing model
of businessman hospital inquire system for business

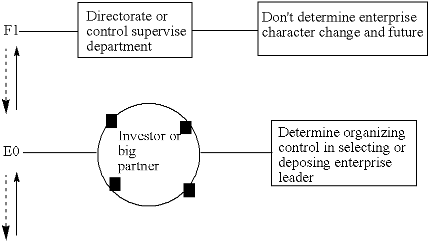

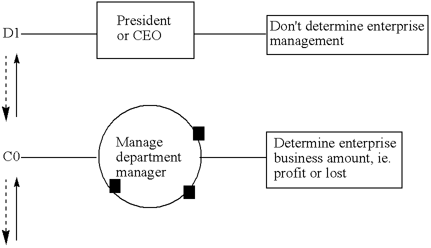

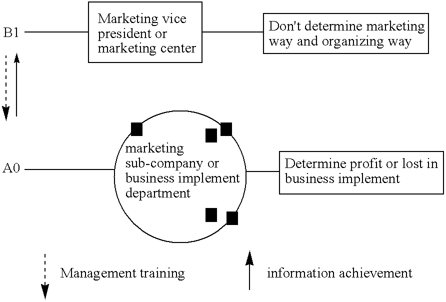

TABLE 5
Delamination structure table in management & distribution model
of businessman hospital inquire system

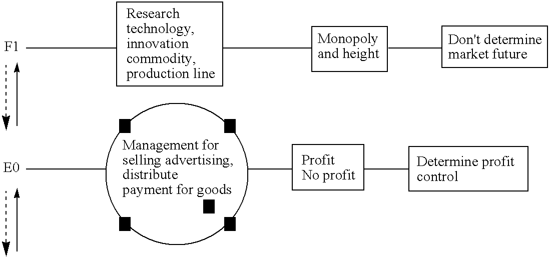

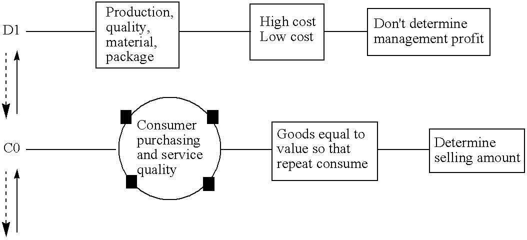

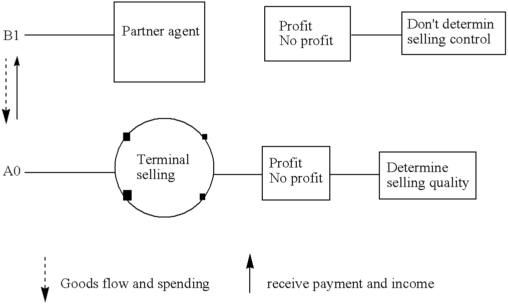

TABLE 6
Procedure for each period and each time quantity change in businessman
hospital inquire system

1. To determine rule of measuring transformation, quantity change and quality change in
each time and each period on enterprise, we take the key kernel data in enterprise state nature
and quantity in currency world usage, ie. the ratio of enterprise (year, month) distribute
goods vs. return payment; the ratio of enterprise (year, month) selling amount vs.
management(include advertising) cost; the ratio of enterprise (year, month) accumulated
gathering vs. selling amount; enterprise (year, month) average profit rate; enterprise (year,
month) total capital debt rate; the ratio of enterprise (year, month) scientific & technological
invest vs. total selling amount and total profit amount. This data is kernel one used to
detennine quality of running enterprise in world usage.
2. Standard enterprise measure model
F1—the ratio of enterprise (year, month) scientific & technological invest vs. total
selling amount
E0—enterprise (year, month) total capital debt rate
D1—enterprise (year, month) average profit rate
C0—the ratio of enterprise (year, month) accumulated gathering vs. selling amount
B1—the ratio of enterprise (year, month) selling amount vs. management cost
A0—the ratio of enterprise (year, month) distribute goods vs. return payment
3. Divide every field and every scale enterprise into three classes, that is:
(1) year selling amount is over 10 millions
(2) year selling amount is over 100 millions
(3) year selling amount is over 500 millions
4. Set up three limits of kernel data for each enterprise, that is:
(1) nature change limit
(2) quantity change warning limit
(3) normal waving limit
5. Each level of enterprise will relate to some limit to determine enterprise to locate
period finally and warn its transformation to other period.

| | |
|---|---|
| (1) Year selling amount is over 10 millions | 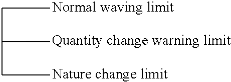 |
| (2) Year selling amount is over 100 millions | 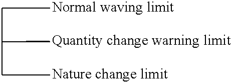 |
| (3) Year selling amount is over 500 millions | 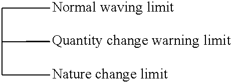 |

6. An enterprise or businessman just depends on the change aroused by key and kernel
data in enterprise running and uses defined character, nature, means, method, warning for now
and future period by business hospital to deal with the future need problems, so supply
function for decision supporting and controlling & driving future.

TABLE 7
64 period partition in businessman hospital inquire system

| | | | | | | | |
|---|---|---|---|---|---|---|---|
| 1 | 2 | 3 | 4 | 5 | 6 | 7 | 8 |
| Register | Training | Plan | Contention | Business | Cooperation | Supervising | Implement |
| | | | | war | | | |
| 9 | 10 | 11 | 12 | 13 | 14 | 15 | 16 |
| Fluency | Block | Communication | Own | Humility | Rest | Decision | Remove |
| | | | | | | | embezzlement |
| 17 | 18 | 19 | 20 | 21 | 22 | 23 | 24 |
| Check | Culture | Rule of law | Marking | Decline | Recovery | Grow up | Control |
| 25 | 26 | 27 | 28 | 29 | 30 | 31 | 32 |
| Manage | Mature | Heavy | Reorganization | Finalize | Trans | Exchange | Carry out |
| finance | | frustration | | the design | | | |
| 33 | 34 | 35 | 36 | 37 | 38 | 39 | 40 |
| Retreat | Monopoly | Competition | Wound | Family | Rift | Stop | Tidy up |
| 41 | 42 | 43 | 44 | 45 | 46 | 47 | 48 |
| Simplify | Encourage | Break off | Prevent | Unify | Increase | Run | Marketing |
| | | | | | | aground | |
| 49 | 50 | 51 | 52 | 53 | 54 | 55 | 56 |
| Replace | Creative | Chief | Limit | Motion | Very | Appear on | Move |
| | | | | | intimate | market | |
| 57 | 58 | 59 | 60 | 61 | 62 | 63 | 64 |
| Management | Advertise | Long-lost | Forbear | Credit | Mistake | Earth | Heaven |

TABLE 8
Code of businessman hospital inquire system

| | | | | | | | | | | | |
|---|---|---|---|---|---|---|---|---|---|---|---|
| 000 | 000 | heaven | 111 | 111 | earth | 011 | 101 | register | 101 | 110 | training |
| 111 | 101 | Plan | 101 | 000 | contention | 101 | 111 | business war | 111 | 101 | cooperation |
| 000 | 100 | supervising | 001 | 000 | implement | 000 | 111 | fluency | 111 | 000 | block |
| 010 | 000 | communication | 000 | 010 | own | 110 | 111 | humility | 111 | 011 | rest |
| 011 | 001 | Decision | 100 | 110 | remove embezzlement | 001 | 111 | check | 111 | 100 | culture |
| 011 | 010 | Rule of law | 010 | 001 | marking | 111 | 110 | decline | 011 | 111 | recovery |
| 011 | 000 | Grow up | 000 | 110 | control | 011 | 110 | administer financial | 100 | 001 | mature |
| 101 | 101 | heavy frustration | 010 | 010 | reorganization | 110 | 001 | exchanges | 100 | 011 | carry out |
| 110 | 000 | retreat | 000 | 011 | monopoly | 111 | 010 | competition | 010 | 111 | wound |
| 010 | 100 | family | 001 | 010 | rift | 110 | 101 | stop | 101 | 100 | tidy up |
| 101 | 110 | Simplify | 011 | 100 | encourage | 000 | 001 | break off | 100 | 000 | prevent |
| 111 | 001 | Unify | 100 | 111 | increase | 101 | 001 | run aground | 100 | 101 | marketing |
| 010 | 001 | Replace | 100 | 010 | creative | 011 | 011 | chief | 110 | 110 | limit |
| 110 | 100 | Motion | 001 | 011 | very intimate | 010 | 011 | appear on market | 110 | 010 | move |
| 100 | 100 | Management | 001 | 001 | advertise | 101 | 100 | long-lost | 001 | 101 | forbear, |
| 001 | 100 | credit | 110 | 011 | mistake | 010 | 101 | set | 101 | 010 | transformation |

### DETAILED DESCRIPTION OF THE INVENTION

1. The characters of the method of businessman hospital inquiring system including electronic software dictionary displayed on screen and appearing information system as click on key position are to divide displayed dictionary into 64 graphs and phrases on screen, multi-layer structure tables. The quantity transformation program in each time and each period and businessman hospital inquiring system code is presented by keyboard character code and location. When clicking number 1 to 64 on screen, you open the information database and get need information.

2. The character of the method of businessman hospital inquiring system locates on two special equipment and use following steps to use or give out information. Two special equipments are the storage equipment and a displaying screen & keyboard for computer progress. The steps begin from order 1. For example, when you click “A” on keyboard, 1A0-3A1 and text will appear on screen.

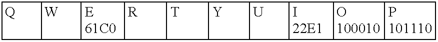

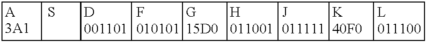

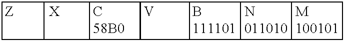

Clicking A on computer keyboard will appear 1A0 → 3A1 graph and text
Clicking B on computer keyboard will appear 111101 graph and text
Clicking C on computer keyboard will appear 1B1 → 58B0 graph and text
Clicking D on computer keyboard will appear 001101 graph and text
Clicking E on computer keyboard will appear 1C1 → 61C0 graph and text
Clicking F on computer keyboard will appear 010101 graph and text
Clicking G on computer keyboard will appear
1D1 → 15D0 graph and text
Clicking H on computer keyboard will appear 011001 graph and text
Clicking I on computer keyboard will appear 1E0 → 22E1 graph and text
Clicking J on computer keyboard will appear 011111 graph and text
Clicking K on computer keyboard will appear 1F1 → 40F0 graph and text
Clicking L on computer keyboard will appear 011100 graph and text
Clicking M on computer keyboard will appear 100101 graph and text
Clicking N on computer keyboard will appear 100010 graph and text
Clicking O on computer keyboard will appear 100010 graph and text
Clicking P on computer keyboard will appear 101110 graph and text

Operation procedure for other 63 enterprise periods and changing inquire system is same as this one.

Code of businessman hospital inquire system

| | | | | | | | | | | | |
|---|---|---|---|---|---|---|---|---|---|---|---|
| 000 | 000 | heaven | 111 | 111 | earth | 011 | 101 | register | 101 | 110 | training |
| 111 | 101 | Plan | 101 | 000 | contention | 101 | 111 | business war | 111 | 101 | cooperation |
| 000 | 100 | supervising | 001 | 000 | implement | 000 | 111 | fluency | 111 | 000 | block |
| 010 | 000 | communication | 000 | 010 | own | 110 | 111 | humility | 111 | 011 | rest |
| 011 | 001 | Decision | 100 | 110 | remove embezzlement | 001 | 111 | check | 111 | 100 | culture |
| 011 | 010 | Rule of law | 010 | 001 | marking | 111 | 110 | decline | 011 | 111 | recovery |
| 011 | 000 | Grow up | 000 | 110 | control | 011 | 110 | manage finance | 100 | 001 | mature |
| 101 | 101 | heavy frustration | 010 | 010 | reorganization | 110 | 001 | exchanges | 100 | 011 | carry out |
| 110 | 000 | retreat | 000 | 011 | monopoly | 111 | 010 | competition | 010 | 111 | wound |
| 010 | 100 | family | 001 | 010 | rift | 110 | 101 | stop | 101 | 100 | tidy up |
| 101 | 110 | Simplify | 011 | 100 | encourage | 000 | 001 | break off | 100 | 000 | prevent |
| 111 | 001 | Unify | 100 | 111 | increase | 101 | 001 | run aground | 100 | 101 | marketing |
| 010 | 001 | Replace | 100 | 010 | creative | 011 | 011 | chief | 110 | 110 | limit |
| 110 | 100 | Motion | 001 | 011 | very intimate | 010 | 011 | appear on market | 110 | 010 | move |
| 100 | 100 | Management | 001 | 001 | advertise | 101 | 100 | long-lost | 001 | 101 | forbear, |
| 001 | 100 | credit | 110 | 011 | mistake | 010 | 101 | set | 101 | 010 | transformation |

1. I declare that the method of businessman hospital inquiring system is my invention.
I think that my invention includes 64 graphs and phrases, multi-delamination structure table, each period & each time quantity change transformation procedure and the code of businessman hospital inquire system.
I think that my invention includes the method of businessman hospital inquire system, electronic software dictionary displayed on screen and appearing information system as click on key position, which character locates on dividing displayed dictionary into 64 graphs and phrases presented by keyboard character code and location on screen, When clicking number 1 to 64 on screen, you open the information database and get need information.
I think that I have invented the method of businessman hospital inquiring system which character locates on two special equipment and uses following steps to use or give out information. Two special equipments are the storage equipment and a displaying screen & keyboard for computer progress. The steps begin from order 1. For example, when you click “A” on keyboard, 1A0-3A1 and text will appear on screen. 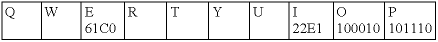 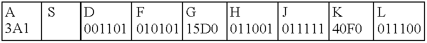 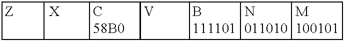
Clicking A on computer keyboard will appear 1A0 → 3A1 graph and text
Clicking B on computer keyboard will appear 111101 graph and text
Clicking C on computer keyboard will appear 1B1 → 58B0 graph and text
Clicking D on computer keyboard will appear 001101 graph and text
Clicking E on computer keyboard will appear 1C1 → 61C0 graph and text
Clicking F on computer keyboard will appear 010101 graph and text
Clicking G on computer keyboard will appear
1D1 → 15D0 graph and text
Clicking H on computer keyboard will appear 011001 graph and text
Clicking I on computer keyboard will appear 1E0 → 22E1 graph and text
Clicking J on computer keyboard will appear 011111 graph and text
Clicking K on computer keyboard will appear 1F1 → 40F0 graph and text
Clicking L on computer keyboard will appear 011100 graph and text
Clicking M on computer keyboard will appear 100101 graph and text
Clicking N on computer keyboard will appear 100010 graph and text
Clicking O on computer keyboard will appear 100010 graph and text
Clicking P on computer keyboard will appear 101110 graph and text
Operation procedure for other 63 enterprise periods and changing inquiring system is this one.
I think that code of businessman hospital inquire system in my invention are:

| | | | | | | | | | | | |
|---|---|---|---|---|---|---|---|---|---|---|---|
| 000 | 000 | heaven, | 111 | 111 | earth, | 011 | 101 | register, | 101 | 110 | training, |
| 111 | 101 | Plan, | 101 | 000 | contention, | 101 | 111 | business war, | 111 | 101 | cooperation, |
| 000 | 100 | supervising, | 001 | 000 | implement, | 000 | 111 | fluency, | 111 | 000 | block, |
| 010 | 000 | communication, | 000 | 010 | own, | 110 | 111 | humility, | 111 | 011 | rest, |
| 011 | 001 | Decision, | 100 | 110 | remove embezzlement, | 001 | 111 | check, | 111 | 100 | culture, |
| 011 | 010 | Rule of law, | 010 | 001 | marking, | 111 | 110 | decline, | 011 | 111 | recovery, |
| 011 | 000 | Grow up, | 000 | 110 | control, | 011 | 110 | manage finance, | 100 | 001 | mature, |
| 101 | 101 | heavy frustration, | 010 | 010 | reorganization, | 110 | 001 | exchanges, | 100 | 011 | carry out, |
| 110 | 000 | retreat, | 000 | 011 | monopoly, | 111 | 010 | competition, | 010 | 111 | wound, |
| 010 | 100 | family, | 001 | 010 | rift, | 110 | 101 | stop, | 101 | 100 | tidy up, |
| 101 | 110 | Simplify, | 011 | 100 | encourage, | 000 | 001 | break off, | 100 | 000 | prevent, |
| 111 | 001 | Unify, | 100 | 111 | increase, | 101 | 001 | run aground, | 100 | 101 | marketing, |
| 010 | 001 | Replace, | 100 | 010 | creative, | 011 | 011 | chief, | 110 | 110 | limit, |
| 110 | 100 | Motion, | 001 | 011 | very intimate, | 010 | 011 | appear on market, | 110 | 010 | move, |
| 100 | 100 | Management, | 001 | 001 | advertise, | 101 | 100 | long-lost, | 001 | 101 | forbear, |
| 001 | 100 | credit, | 110 | 011 | mistake, | 010 | 101 | set, | 101 | 010 | transformation |
